(19) United States
(12) Patent Application Publication
(10) Pub. No.: US 2010/0242051 A1
(43) Pub. Date: Sep. 23, 2010

(54) ADMINISTRATION MODULE, PRODUCER AND CONSUMER PROCESSOR, ARRANGEMENT THEREOF AND METHOD FOR INTER-PROCESSOR COMMUNICATION VIA A SHARED MEMORY

(76) Inventors: Kai Roettger, Stuttgart (DE); Hamit Hacioglu, Stuttgart (DE)

Correspondence Address: KENYON & KENYON LLP, ONE BROADWAY, NEW YORK, NY, 10004, US

(21) Appl. No.: 12/303,923

(22) PCT Filed: Sep. 24, 2007
(86) PCT No.: PCT/EP07/60087

§ 371 Date: May 6, 2010

(30) Foreign Application Priority Data
Feb. 7, 2007 (EP) 07101907.9

(51) Int. Cl. G06F 9/44; G06F 12/00

(52) U.S. Cl. 719/312; 711/147; 711/E12.001

(57) ABSTRACT

Administration module, producer and consumer processor, arrangement thereof and method for inter-processor communication via a shared memory, wherein the module includes: a device for storing and administering the states of triple-buffers, each buffer having a read-, a write- and an idle-sub-buffer; a device for communicating with at least one producer and at least one consumer processor, and wherein the administration device is formed to determine a targeted read- or write-sub-buffer from the triple-buffers in response to a producer or consumer processor access.

### BACKGROUND INFORMATION

The present invention relates to an administration module, a producer and consumer processor, an arrangement thereof and a method for inter-processor communication via a shared memory.

The task of inter-processor communication is usually solved by a common shared memory approach as shown in FIG. 1.

N processors PO . . . Pn have access to the same memory SM via interfaces 40, 50 and can exchange data through m shared buffers BO . . . Bm. In order to preserve system performance, the following conditions have to be fulfilled.

In the first place, all processors are totally asynchronous, ie read and write operations from and to the buffers may happen at any time. In addition, the buffer-size is not limited, which means that atomic read and write operations are not possible. Finally, no blocking mechanisms are allowed, ie processors can not wait for each other to complete a read or write operation.

Considering these circumstances, granting data consistency is the major issue in prior art solutions. Several publications have dealt with such issue and solved the problem. One suitable solution is the triple-buffering approach introduced in ‘A Three-Slot Asynchronous Reader/Writer Mechanism for Multiprocessor Real-Time Systems. Technical Report YCS-286, Department of Computer Science, University of York, January 1997’ by J. Chen and A. Burns. The solution covers use cases under the following restrictions. First, each buffer is assigned to 2 processors, one of them being a dedicated producer PP, which exclusively writes to a buffer Bx, the other being a dedicated consumer CP, which exclusively reads from the buffer Bx. Second, only the most recent consistent data-set is of interest. Overwriting unused data-sets is not critical. The basic principle may be seen from FIG. 2.

Each buffer Bx of the shared memory SM consists of three sub-buffers SBO . . . SB2, each able to host the whole data-set. One sub-buffer (currently SB1) is reserved by the producer as the write-sub-buffer WSB and is currently filled with new data. Consequently, the content is inconsistent and not suitable for reading. One sub-buffer (currently SBO) is reserved by the consumer as the read-sub-buffer RSB and is currently read out. The content is consistent and has to be protected from writing. The third sub-buffer (currently SB3) is idle, ie the idle-sub-buffer ISB, and becomes the write-sub-buffer WSB whenever the producer has a new set of data for writing. When the consumer requests a new set of data for reading, the idle-sub-buffer ISB becomes the read-sub-buffer RSB, if the producer dumped a new set of data in the meanwhile.

Thus, there is a remarkable amount of administrational overhead necessary for managing the sub-buffers SO . . . S2. This can be done by the processors PP and CP themselves using the appropriate software. But according to the above mentioned report of J. Chen and A. Burns there is still the requirement of a compare-and-swap instruction, which has to be supported by the processors.

DE 44 20 123 discloses a bank-switching device for microcomputers, which switches the bank in response to an address validity signal to avoid waiting cycles while switching.

DE 100 03 006 discloses an arrangement and method for signal processing and storing, in which data-transfer of filtering coefficients and input/output values is controlled by a controller.

### SUMMARY

Example embodiments of the present invention provide for inter-processor communication with low administrative burden to the processors, which is the same way fast, simple and efficient, and may be implemented economically.

Example embodiments of the present invention provide an administration module, including a device for storing and administering the states of triple-buffers, each buffer having a read-, a write- and an idle-sub-buffer, a device for communicating with at least one producer and at least one consumer processor, wherein said administration device is formed to determine, in response to a producer processor access, a targeted write-sub-buffer, to look up an idle-sub-buffer-ID from said storing means, to deliver this idle-sub-buffer-ID to be the new write-sub-buffer to the appropriate producer processor via said communication device, and to update each state of said sub-buffers according to the current assignments, and wherein said administration device is further formed to determine, in response to a consumer processor access, a targeted read-sub-buffer, to check if the content of said idle-sub-buffer is more recent than the content of said read-sub-buffer, and if not, to return this read-sub-buffer-ID to be the new read-sub-buffer to the appropriate consumer processor via said communication device, otherwise, to look up the idle-sub-buffer-ID and to deliver this idle-sub-buffer-ID to be the new read-sub-buffer to the appropriate consumer processor via said communication device.

One aspect about the module is that the sub-buffers are handled independently, thereby freeing the processors from nearly all administrative overhead and special requirements such as compare-and-swap instructions. The remaining overhead is a single access to the administration module, in order to fetch the next write/read-sub-buffer for a particular buffer. In the most common case, the interface is a standard processor local bus, consisting of address, data and control lines. Thus, for the first time, fast, simple and efficient communication between the processors may be realized. Since furthermore the administration module is a piece of hardware, which is accessible from all processors, implementation costs are cut down to such module.

Example embodiments of said administration module provide for efficient buffer access from the consumer processors point of view. In a first aspect, said storing device includes a FIFO (First-In-First-Out)-stack, and said administration device is formed to configure each of said buffers to enquire their ID into said FIFO-stack each time a new data-set has arrived, and to send an interrupt request via said communication device to the appropriate consumer processor. Thus, the consumer processor immediately knows without polling the related buffer, which buffer has been updated and can read the data-set from the shared memory after determining the correct read-sub-buffer.

If however the amount of buffers to process is very small, ie smaller than the data bus width, a register approach is more efficient.

Therefore, in a second aspect, said storing device includes at least one register, and said administration device is formed to configure each of said buffers to set a buffer-related bit in said register each time a new data-set has arrived, and to send an interrupt request via said communication device to the appropriate consumer processor. By evaluating the register content, the consumer processor gets all pending buffers with a single read access instead of successively emptying the FIFO.

Example embodiments of the present invention provide a producer processor for communication with said administration module, including a first device for communicating with a shared memory, a second device for communicating with said module, and wherein said processor is formed to request a write-sub-buffer from said module via said second communication device, to receive a current write-sub-buffer-ID from said module via said second communication device, and to send a data-set to this write-sub-buffer via said first communication device.

Example embodiments of the present invention provide a consumer processor for communication with said administration module, including a first device for communicating with a shared memory, a second device for communicating with said module, and wherein said processor is formed to request a read-sub-buffer from said module via said second communication device, to receive a current read-sub-buffer-ID from said module via said second communication device, and to read a data-set from this read-sub-buffer via said first communication device.

Only marginal changes to their operational behaviour and interfaces are required to make them communicate fast and efficient. This cuts down implementation costs.

Accordingly, said consumer processor is formed to request a read-sub-buffer from said module via said second communication device in response to an interrupt request of said module. The request may be directed to a FIFO-stack or a register, which may be provided in the administration module as already mentioned. Thus, the consumer processor immediately knows which buffer has been updated and can read the data-set without delay.

Example embodiments of the present invention provide an arrangement for administering inter-processor communication via a shared memory, the arrangement including said administration module, and such module being connected to at least one producer and at least one consumer processor as already described.

Example embodiments of the present invention provide simple structure and thus may be easily and economically integrated onto a respective board.

In a first aspect, a device for arbitrating is provided in a communication path between said processors and said administration module for scheduling concurrent processor accesses. As an effect, communication between multiple processors may be managed with one administration module only. Thus, efficiency of the arrangement is improved in a simple and economical manner.

Preferably, in a second aspect, said device for arbitrating is integrally formed with said administration module. Consequently, the number of parts to be integrated onto a board is reduced, which saves necessary space and also cuts down costs.

Example embodiments of the present invention provide a method of administering the states of triple-buffers for inter-processor communication via a shared memory, each buffer having a read-, a write- and an idle-sub-buffer, said method including the steps of producer processor access, wherein the targeted buffer is determined, the idle-sub-buffer-ID is looked up, this idle-sub-buffer-ID is delivered to the appropriate producer processor to be the new write-sub-buffer, and each state of said sub-buffers is updated according to the current assignments, and consumer processor access, wherein the targeted buffer is determined, the content of the idle-sub-buffer is checked whether to be more recent than the state of said read-sub-buffer, and if not, this read-sub-buffer-ID is returned to be the new read-sub-buffer to the appropriate consumer processor, otherwise, the idle-sub-buffer-ID is looked up and delivered to be the new read-sub-buffer to the appropriate consumer processor.

A minimum number of steps may be necessary for gathering the required information. Thus, for the processors, efficient access to the respective sub-buffers is possible without administrative burden. The method also provides for cheap realization, since it is easy to implement into and to maintain in a piece of hardware.

In a first aspect, accordingly, the method includes the step of administrative access, wherein the state of each buffer can be reset and buffer specific configurations can be made. This allows for a defined starting configuration and reset of shared memory access the same as it opens for further accelerations.

Preferably, in a second aspect, the step of administrative access includes interrupt activation for said buffers upon each producer processor access. Thus, the consumer processor immediately knows which buffer has been updated as already described above.

In a third aspect, the step of administrative access includes propagation of buffer-Ms upon each producer processor access. This enables quick access of the consumer processor according to the current settings without polling the related buffer.

In the following, example embodiment of the present invention will be explained in more detail. Similar parts and parts of similar effect have been given same reference numerals.

### BRIEF DESCRIPTION OF THE DRAWINGS

FIG. 1 illustrates a conventional common shared memory approach;

FIG. 2 illustrates a conventional basic principle of triple buffering;

FIG. 3 illustrates an administration module for triple buffers according to example embodiments of the present invention;

FIG. 4 illustrates a sample address map of the administration module of FIG. 3 for managing 4096 triple-buffers, and

FIG. 5 illustrates an interrupting mechanism provided in the administration module of FIG. 3.

### DETAILED DESCRIPTION

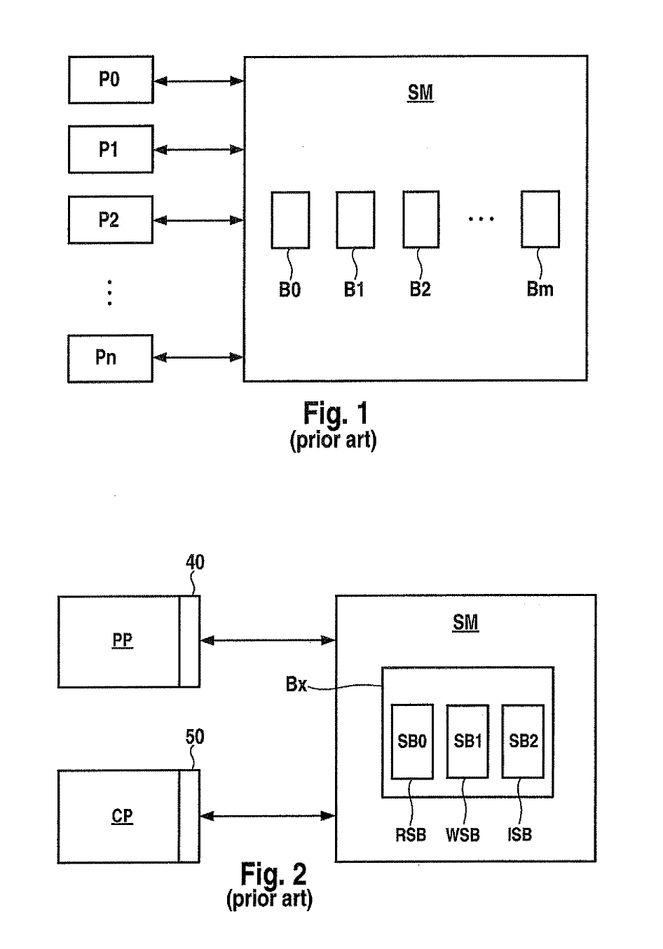

FIGS. 1 and 2 show a known common shared memory approach and a basic principle of triple buffering, respectively. Such conventional arrangements have already been discussed above.

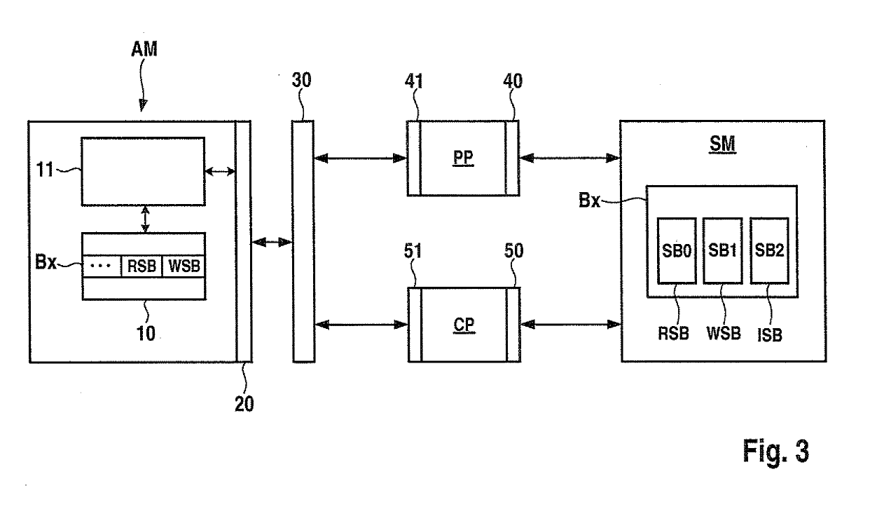

FIG. 3 shows an administration module AM for triple buffers SBO . . . SB2 according to example embodiments of the present invention, which manages communication of a producer processor PP and a consumer processor CP via shared memory SM. The administration module AM is provided with a storing device 10, which in this case is a state table for holding write-, read and idle-sub-buffer-lds for each buffer Bx. The storing device 10 is managed by an administration device 11, which in turn communicates to the outside via interface 20. Concurrent access to the module AM from multiple processors is achieved by a device for arbitration 30, which is located in the communication path connecting interface 20 of the module AM with interfaces 41, 51 of the processors PP, CP. Such device for arbitration 30 may also be formed integrally with the administration module AM in order to reduce the number of parts necessary on a board. The processors PP, CP are further provided with interfaces 40, 50 to communicate via shared memory SM, which includes triple-buffers Bx each having sub-buffers SBO . . . SB2, the latter being alternating read RSB, write WSB or idle-sub-buffers ISB.

The module supports a producer access (read access to producer area), wherein the administration module AM determines the targeted buffer Bx according to the address offset, looks up the idle-sub-buffer ISB for this buffer Bx in the state-table 10, delivers this sub-buffer-ld (also called index in the following) as read value to the producer processor PP and updates the state-table 10. Now, the producer processor PP can use this sub-buffer WSB within the shared memory SM exclusively for dumping its new data-set.

Further, in a consumer access (read access to a consumer area), the administration module AM determines the targeted buffer Bx according to the address offset and checks if new data has been dumped since the last consumer access. If no new data-set is available the appropriate flag is returned as read value to the consumer processor CP. Otherwise, the module AM looks up the idle-sub-buffer ISB, which holds the most recent consistent data-set for this buffer Bx, delivers this sub-buffer index as read value to the consumer and updates the state-table. Now, the consumer processor CP can use this sub-buffer within the shared memory SM exclusively for reading the most recent data-set.

Finally, in an administrative access (write access to a consumer/producer area), the state of each buffer Bx can be reset and buffer specific configurations can be made, like interrupt activation as described later.

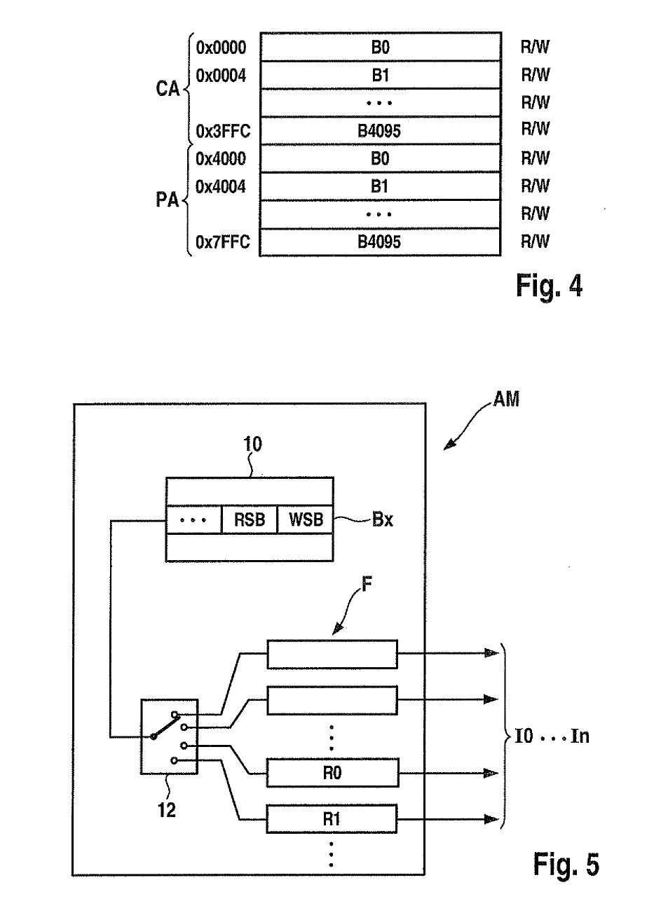

FIG. 4 shows a sample address map of the administration module AM of FIG. 3 for managing 4096 triple-buffers. Read/write buffers BO . . . B4095 constitute a 16-bit consumer area CA or producer area PA of the share memory SM, respectively.

From the producer processors point of view, this support is enough for getting an efficient software flow. Every time, the producer processor PP dumped a new set of data to the current write-sub-buffer WSB, it invokes the administration module AM in order to acknowledge this write-sub-buffer WSB and get the next write-sub-buffer WSB for the next set of data. Both with only one additional read access to the administration module AM. From the consumer processors point of view each buffer Bx of interest has to be polled for the arrival of new data. Therefore, according to example embodiments of the present invention, an additional interrupting mechanism has been developed for an efficient software flow without polling. Such mechanism is explained in the following.

FIG. 5 shows an interrupting mechanism provided in the administration module AM of FIG. 3. Each buffer Bx can be configured to enqueue its ID into a FIFO F, each time a data-set is dumped by the producer processor PP. As soon as the FIFO F contains an entry, an interrupt request 10 . . . . In is send to the appropriate consumer processor CP. By evaluating the FIFO F entry, the consumer processor CP immediately knows which buffer Bx has been updated and can read the data-set from the shared memory SM after determining the correct read-sub-buffer RSB.

If the amount of buffers Bx to process however is very small, ie smaller than the data bus width, a register approach is more efficient. Each buffer Bx is then configured to set a particular bit in a register R, each time a data-set is dumped by the producer. As soon as one bit is set, an interrupt request is send to the appropriate consumer processor CP. By evaluating the register content, the consumer processor CP gets all pending buffers Bx with a single read access instead of successively emptying the FIFO F.

In both the FIFO and register approach, on each producer access, propagation of buffer Bx is made towards a device for position configuration 12 of each buffer Bx in the FIFO-stack F and/or the register R. Therefore, both methods of acceleration may be incorporated into the administration module AM, whichever may be at least configured to be in effect.

As can be seen by way of example, too, since the administration module AM takes the burden of managing the buffers Bx from the respective processors PP CP, fast and simple, same as efficient processor communication is provided at low costs. The additional placement of module AM within the known environment of processors and shared memory is acceptable taking into account the merits thereof.

1-13. (canceled)

14. An administration module for inter-processor communication via a shared memory, comprising:
a storage and an administration device adapted to store and administer states of triple-buffers, each buffer having a read-, a write- and an idle-sub-buffer; and
a device adapted to communicate with at least one producer and at least one consumer processor;
wherein the administration device is adapted to perform, in response to a producer processor request, requesting a write-sub-buffer, the following: a look up an idle-sub-buffer-ID from the storage device, a delivery of the idle-sub-buffer-ID to be a new write-sub-buffer to an appropriate producer processor via the communication device, and an update of each state of the sub-buffers according to current assignments; and
wherein the administration device is adapted to perform, in response to a consumer processor request, requesting a read-sub-buffer, the following: a check if a content of the idle-sub-buffer is more recent than the content of the read-sub-buffer, and if not, a return of the read-sub-buffer-1D to be the new read-sub-buffer to the appropriate consumer processor via the communication device, otherwise, a look up of the idle-sub-buffer-1D and a delivery of the idle-sub-buffer-ID to be the new read-sub-buffer to the appropriate consumer processor via the communication device.

15. The administration module according to claim 14, wherein the storage device includes a FIFO-stack, and the administration device is adapted to configure each of the buffers to enqueue their ID into the FIFO-stack in case the write-sub-buffer has changed, and to send an interrupt request via the communication device to the appropriate consumer processor.

16. The administration module according to claim 14, wherein the storage device includes at least one register, and the administration device is adapted to configure each of the buffers to set a buffer-related bit in the register in case the write-sub-buffer has changed, and to send an interrupt request via the communication device to the appropriate consumer processor (CP).

17. A producer processor for communication with an administration module for inter-processor communication via a shared memory, the administration module including a storage and an administration device adapted to store and administer states of triple-buffers, each buffer having a read-, a write- and an idle-sub-buffer, and a device adapted to communicate with the producer processor and at least one consumer processor, wherein the administration device is adapted to perform, in response to a producer processor request, requesting a write-sub-buffer, the following: a look up an idle-sub-buffer-ID from the storage device, a delivery of the idle-sub-buffer-ID to be a new write-sub-buffer to an appropriate producer processor via the communication device, and an update of each state of the sub-buffers according to current assignments, and wherein the administration device is adapted to perform, in response to a consumer processor request, requesting a read-sub-buffer, the following: a check if a content of the idle-sub-buffer is more recent than the content of the read-sub-buffer, and if not, a return of the read-sub-buffer-ID to be the new read-sub-buffer to the appropriate consumer processor via the communication device, otherwise, a look up of the idle-sub-buffer-ID and a delivery of the idle-sub-buffer-ID to be the new read-sub-buffer to the appropriate consumer processor via the communication device, comprising:
a first device adapted to communicate with the shared memory; and
a second device adapted to communicate with the module;
wherein the producer processor is adapted to request a write-sub-buffer from the module via the second device, to receive a current write-sub-buffer-ID from the module via the second device, and to send a data-set to the write-sub-buffer via the first device.

18. A consumer processor for communication with an administration module for inter-processor communication via a shared memory, the administration module including a storage and an administration device adapted to store and administer states of triple-buffers, each buffer having a read-, a write- and an idle-sub-buffer, and a device adapted to communicate with at least one producer processor and the consumer processor, wherein the administration device is adapted to perform, in response to a producer processor request, requesting a write-sub-buffer, the following: a look up an idle-sub-buffer-ID from the storage device, a delivery of the idle-sub-buffer-ID to be a new write-sub-buffer to an appropriate producer processor via the communication device, and an update of each state of the sub-buffers according to current assignments, and wherein the administration device is adapted to perform, in response to a consumer processor request, requesting a read-sub-buffer, the following: a check if a content of the idle-sub-buffer is more recent than the content of the read-sub-buffer, and if not, a return of the read-sub-buffer-ID to be the new read-sub-buffer to the appropriate consumer processor via the communication device, otherwise, a look up of the idle-sub-buffer-ID and a delivery of the idle-sub-buffer-ID to be the new read-sub-buffer to the appropriate consumer processor via the communication device, comprising:
a first device adapted to communicate with the shared memory; and
a second device adapted to communicate with the module;
wherein the consumer processor is adapted to request a read-sub-buffer from the module via the second device, to receive a current read-sub-buffer-ID from the module via the second device, and to read a data-set from the read-sub-buffer via the first device.

19. The consumer processor according to claim 18, wherein the consumer processor is adapted to request a read-sub-buffer from the module via the second device in response to an interrupt request of the module.
